(19) United States
(12) Patent Application Publication
(10) Pub. No.: US 2018/0244295 A1
(43) Pub. Date: Aug. 30, 2018

(54) STROLLER

(71) Applicant: DOREL JUVENILE GROUP, INC., Foxboro, MA (US)

(72) Inventors: Gerjan STORM, Eindhoven (NL); John Gert Til VAN DIJK, Helmond (NL); Fortunatus Johannes DE HAAS, Beesd (NL)

(73) Assignee: DOREL JUVENILE GROUP , INC.

(21) Appl. No.: 15/753,456

(22) PCT Filed: Jul. 20, 2016
(86) PCT No.: PCT/EP2016/067279

§ 371 Date: Feb. 19, 2018

(30) Foreign Application Priority Data
Aug. 19, 2015 (NL) 2015318

(51) Int. Cl. B62B 7/06

(52) U.S. Cl. CPC B62B 7/062; B62B 2205/20; B62B 2205/06

(57) ABSTRACT

A stroller is foldable from an erect position to a collapsed position and vice versa. The stroller comprises a collapsible folding mechanism provided with a push bar and at least one four-bar linkage mechanism. The push bar comprises a first part provided with a handle. The first part is pivotably connected to a first bar of the four-bar linkage mechanism. The push bar further comprises a second part pivotably connected to a second bar of the four-bar linkage mechanism. Ends of the first part and the second part are pivotably connected at a pivot to each other. The first part and the second part are detachably lockable with respect to each other in the erect position of the stroller to prevent collapsing of the four-bar linkage mechanism.

### FIELD OF THE INVENTION

The invention relates to a stroller being foldable from an erect position to a collapsed position and vice versa, which stroller comprises a collapsible folding mechanism provided with a push bar and at least one four-bar linkage mechanism.

### BACKGROUND OF THE INVENTION

Such a stroller, which is known from U.S. Pat. No. 1,035,976A, comprises a push bar pivotally connected at an end to a longitudinal side member and pivotally connected at a distance from said end to a longitudinal guard member. At a side remote of the push bar, an upright member is pivotally connected to the longitudinal side member and pivotally connected to a longitudinal guard member. The push bar, longitudinal side member, longitudinal guard member and upright member form a four-bar linkage mechanism. The stroller comprises two such four-bar linkage mechanisms, one on each side of the stroller. When the stroller is erected the push bars are held against forward movement by folding rule-joint braces composed of links pivoted together and pivoted at their ends to the push bars and to the side members, respectively.

A disadvantage of such a stroller is that the push bar, being used amongst others to push the stroller in a forward direction, forms part of the four-bar linkage mechanism, so that the movement of the push bar is directed by and identical to the movement of a bar of the four-bar linkage mechanism. This limits the freedom of the designer.

### SUMMARY OF THE INVENTION

At least one of the objects of the invention is to provide a stroller which can easily be folded into a compact shape.

This object is accomplished with the stroller according to the invention in that the push bar comprises a first part provided with a handle, which first part is pivotably connected to a first bar of the four-bar linkage mechanism, which push bar further comprises a second part pivotably connected to a second bar of the four-bar linkage mechanism, whilst ends of the first part and the second part are pivotably connected at a pivot to each other, wherein the first part and the second part are detachably lockable with respect to each other in the erect position of the stroller to prevent collapsing of the four-bar linkage mechanism.

After unlocking the first part and the second part of the push bar in the erect position of the stroller, a user will move the handle so that the first part of the push bar will pivot with respect to the first bar of the four-bar linkage mechanism. Since the second part of the push bar is pivotally connected to the first part of the push bar as well as to the second bar of the four-bar linkage mechanism, pivoting of the first part of the push bar with respect to the first bar of the four-bar linkage mechanism, will cause pivoting of all the bars of the four-bar linkage mechanism, whereby the stroller will be folded to the collapsed position.

The push bar is not part of the four-bar linkage mechanism so that the four-bar linkage mechanism and the push bar can individually be optimized for performing their function.

Preferably the first bar and the second bar of the four-bar linkage mechanism are connected to each other near one side by a third bar and near another side by a fourth bar.

The four-bar linkage mechanism can be folded smoothly.

If the first bar is located at a higher level than the second bar, wheels of the stroller can for example be connected to or near ends of the second bar. The distance between the opposite ends of the second bar can be relatively large whereby a space will be obtained for a relatively large basket.

An embodiment of the stroller according to the invention is characterized in that the first part and the second part of the push bar are detachably lockable with respect to each other at least near the pivot.

By providing a lock near or at the pivot, the four-bar linkage mechanism can easily be locked in at least the erect position of the stroller. Preferably the unlocking of the first part and the second part of the push bar can be activated from the first part, and more preferably from the handle.

Another embodiment of the stroller according to the invention is characterized in that in the erect position of the stroller, the first part and the second part of the push bar are in line with each other.

Such an alignment, when locked, provides a strong push bar, which can easily maintain the four-bar linkage mechanism in the desired erect position.

Another embodiment of the stroller according to the invention is characterized in that the four-bar linkage mechanism is a parallelogram linkage mechanism.

With such a parallelogram linkage mechanism opposite bars of the parallelogram linkage mechanism, will always maintain parallel to each other. In the collapsed position of the stroller, the bars of the parallelogram linkage mechanism can be folded very close to each other.

A seat or a pram body will maintain the same for example horizontal orientation during folding of the frame.

Another embodiment of the stroller according to the invention is characterized in that the four-bar linkage mechanism comprising an upper bar, a lower bar, a front bar and a rear bar, wherein the lower bar is pivotably connected at a first pivot and a second pivot to the front bar and the rear bar respectively, whilst the upper bar is pivotably connected at a third pivot and a fourth pivot to the front bar and the rear bar respectively, wherein the first part of the push bar is pivotably connected at a fifth pivot to the upper bar and the second part of the push bar is pivotably connected at a sixth pivot to the lower bar, whilst ends of the first part and the second part are pivotably connected to each other at the pivot, being the seventh pivot.

With such an orientation of the pivots and push bar, the first part of push bar, being provided with the handle can easily extend upwards under any desired angle with the horizontal, so that the designer of the stroller has great freedom to optimize the orientation of the push bar as well as the dimensions of the four-bar linkage mechanism.

While folding the frame, a seat, adapter, a pram body or the like can stay on the frame. Wheels connected to the frame will remain on the ground, whilst the push bar is located at a distance from wheels. Since all wheels are constant on the ground during folding the stroller, a stable position of the stroller is maintained. This is also advantageous if the wheels have become dirty.

Preferably the four-bar linkage mechanism is a parallelogram linkage mechanism, whereby pivoting the first part of the push bar will result in a gradually continuous folding of the four-bar linkage mechanism.

Another embodiment of the stroller according to the invention is characterized in that at least in the erect position at least one of the first part and second part of the push bar extend in another direction as the front bar and the rear bar.

With such orientation the push bar, when locked, will easily prevent folding of the four-bar linkage mechanism.

Another embodiment of the stroller according to the invention is characterized in that the fifth pivot is located between the third pivot and the forth pivot, whilst the first pivot is located between the second pivot and the sixth pivot.

Such an orientation of the pivots, provides a folding mechanism which can be collapsed in a compact form in an intuitive way.

Another embodiment of the stroller according to the invention is characterized in that during folding of the stroller, the first part of the push bar pivots in opposite direction with respect to the upper bar as the front bar and the rear bar, whilst the second part pivots in the same direction with respect to the lower bar as the front bar and the rear bar or vice versa.

In this manner, the folding mechanism can easily be collapsed in a compact form.

### BRIEF DESCRIPTION OF THE DRAWINGS

The stroller according to the invention will further be explained with reference to the drawings, wherein,

FIG. 1 shows a perspective view of a first embodiment of a stroller according to the invention,

FIG. 2 shows a side view of the stroller as shown in FIG. 1,

FIG. 3 shows a bottom view of the stroller as shown in FIG. 1,

FIG. 4A and 4B show schematic views of the folding mechanism of the stroller as shown in FIG. 1 in an erect position and partially collapsed position of the stroller,

FIGS. 5A-5D show side views of the stroller as shown in FIG. 1, in respectively an erect position, a position wherein the length of the push bar is reduces, a partially collapsed position and a fully collapsed position of the stroller,

FIG. 6 shows a perspective view of a second embodiment of a stroller according to the invention,

FIG. 7 shows a side view of the stroller as shown in FIG. 6.

In the drawings, like reference numerals refer to like elements.

### DESCRIPTION OF PREFERRED EMBODIMENTS

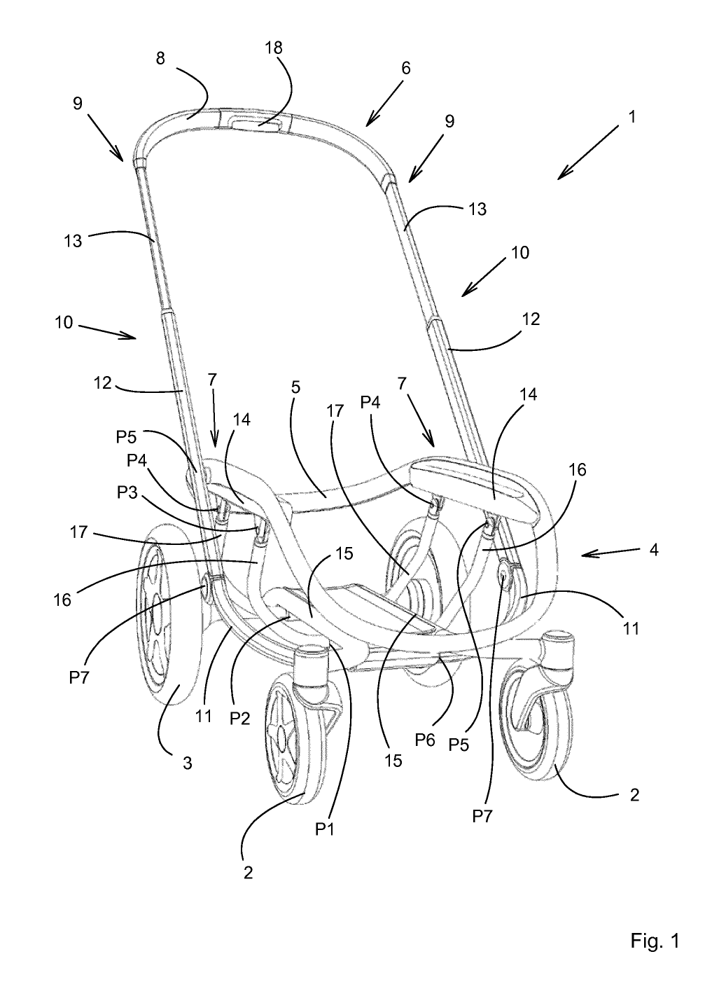

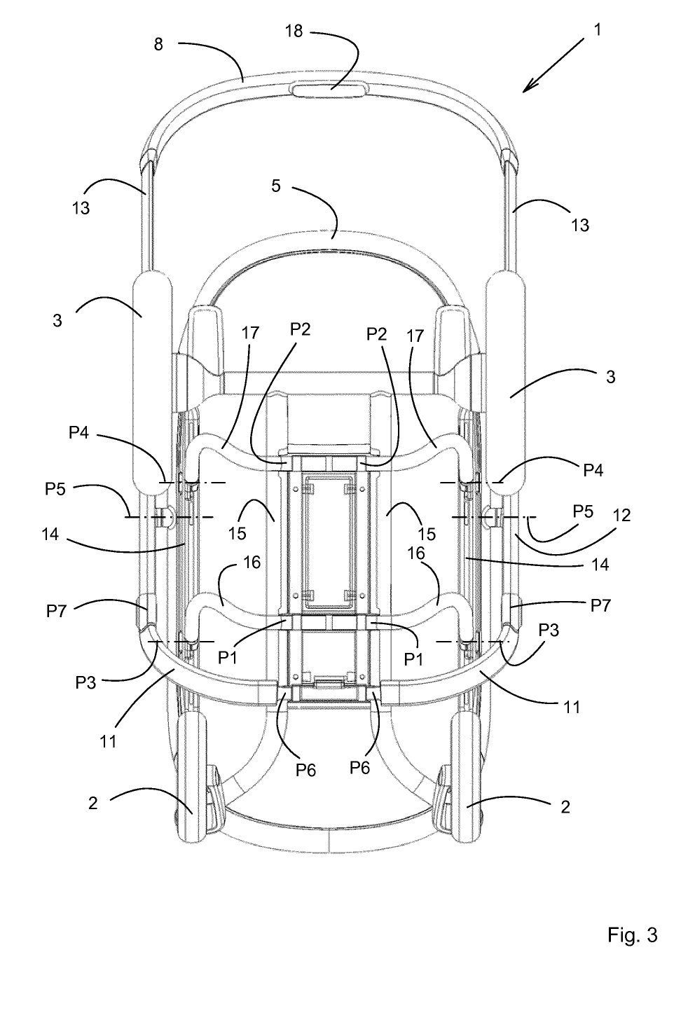

FIGS. 1-3 show perspective view, a side view and a bottom view of a first embodiment of a stroller 1 according to the invention.

The stroller 1 comprises two front wheels 2, two rear wheels 3, a collapsible folding mechanism 4 supported by the wheels 2, 3 and a ring shape frame 5 to which a seat for a child can be detachably connected. To better show the relevant aspects of the invention the seat is not shown in the figures.

The collapsible folding mechanism 4 is provided with a push bar 6 and two four-bar linkage mechanisms 7, one on each side of the stroller 1. The push bar 6 is U-shaped and comprises a bridge part 8 and two leg portions 9. The bridge part 8 forms the handle of the push bar 6. Each leg portion 9 comprises an extendable first part 10 and a second part 11. The first part 10 is provided with a lower portion 12 and an upper portion 13 which is slidable located inside the lower portion 12. The upper portion 13 is connected at a side remote of the lower portion 12 to the bridge part 8.

Each four-bar linkage mechanism 7 comprises an upper bar 14, a lower bar 15, a front bar 16 and a rear bar 17. The lower bar 15 is pivotably connected at a first pivot P1 to the front bar and at a second pivot P2 to rear bar 17. The upper bar 14 is pivotably connected at a third pivot P3 to the front bar 16 and at a fourth pivot P4 to the rear bar 17. The first part 10 of the push bar 6 is pivotably connected at a fifth pivot P5 to the upper bar 14. The second part 11 of the push bar 6 is pivotably connected at a sixth pivot P6 to the lower bar 15. Ends of the first part 10 and the second part 11 are pivotably connected to each other at a seventh pivot P7.

The pivotably connected upper bar 14, lower bar 15, front bar 16 and rear bar 17 form a parallelogram linkage mechanism, whereby the upper bar 14 and the lower bar 15 always remain parallel. Also the front bar 16 and rear bar 17 always remain parallel.

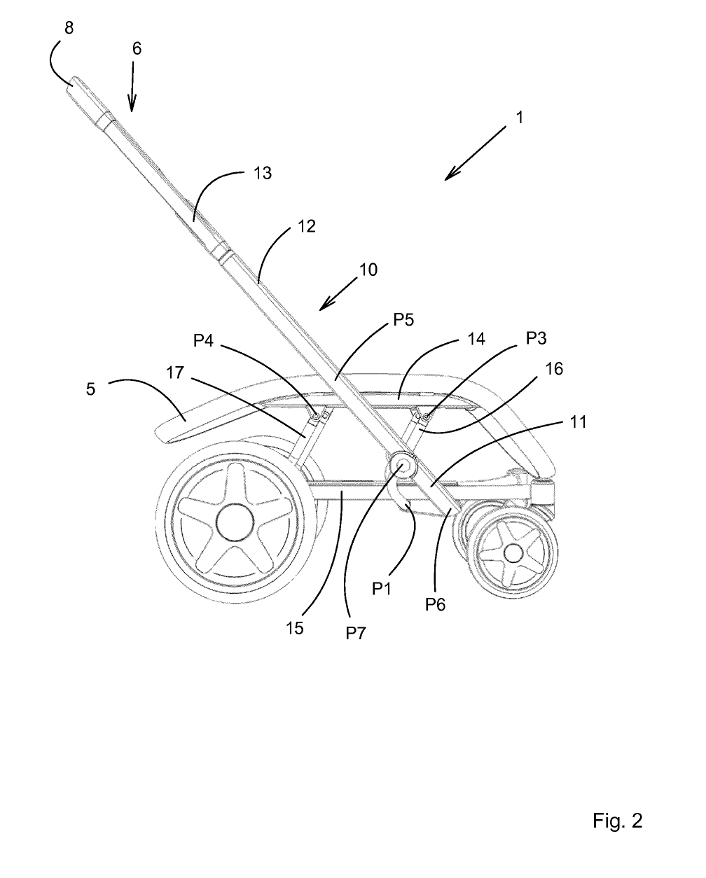

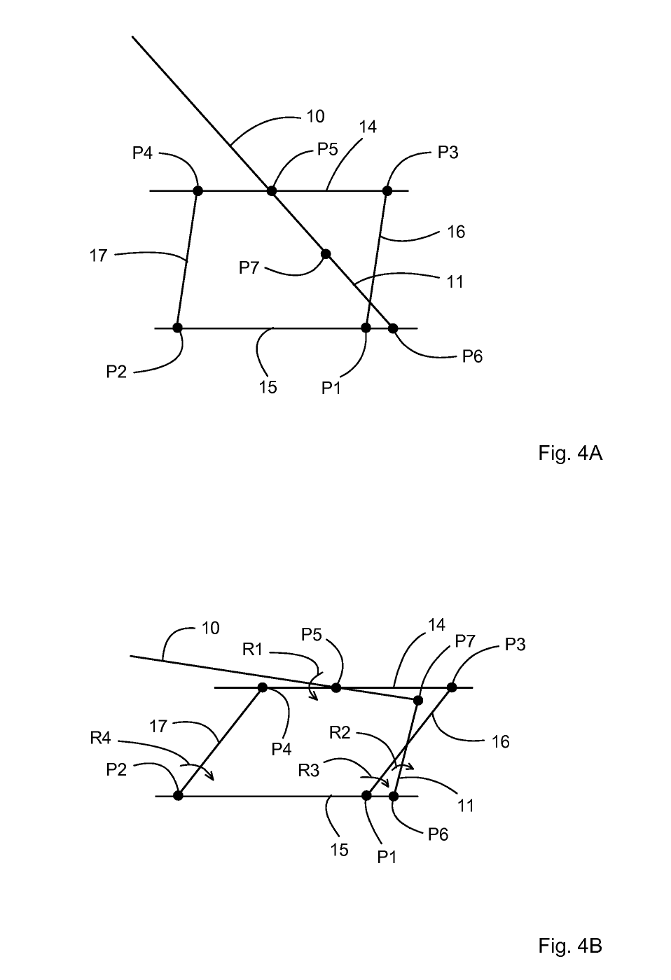

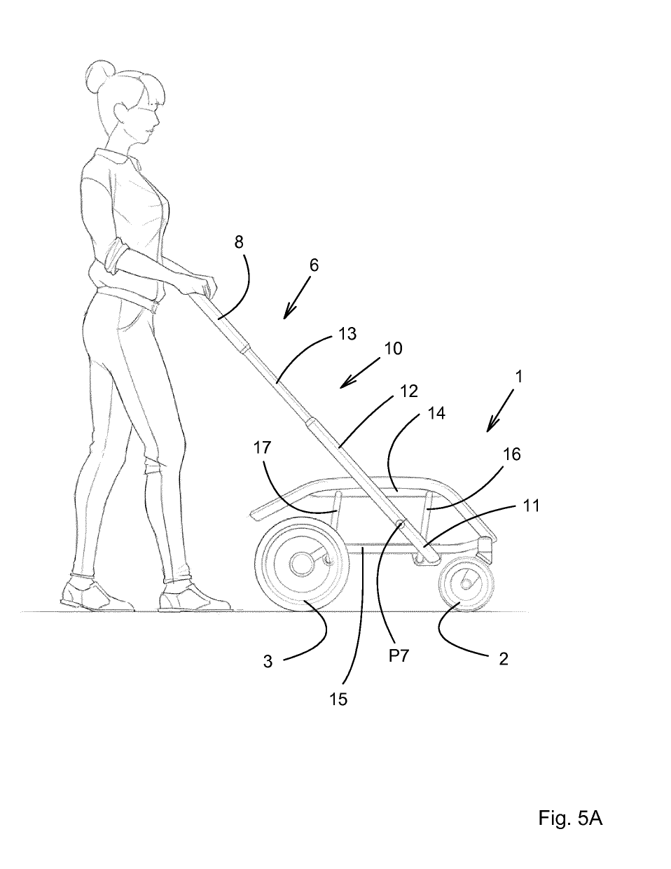

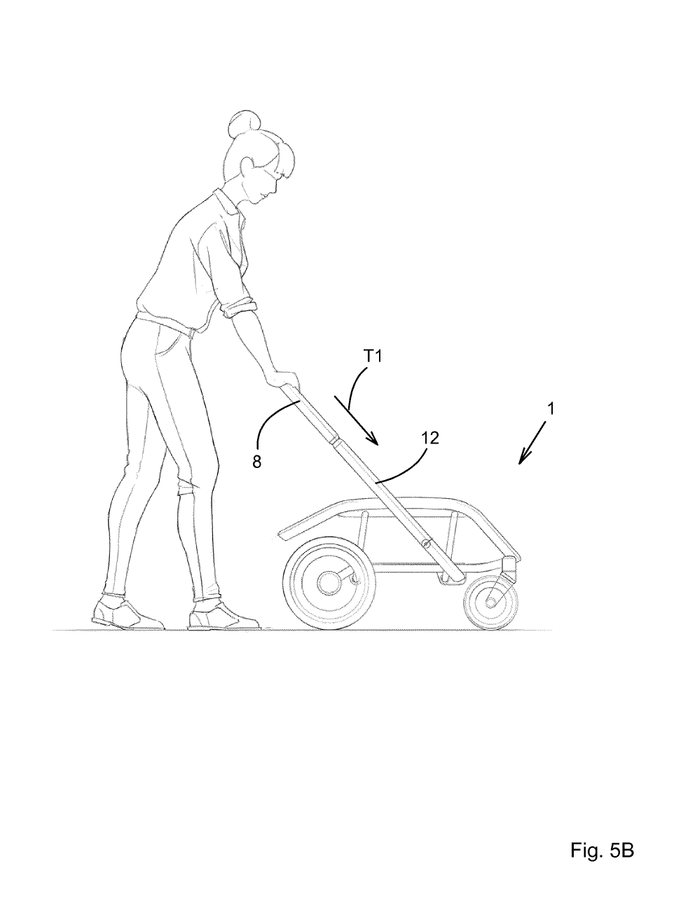

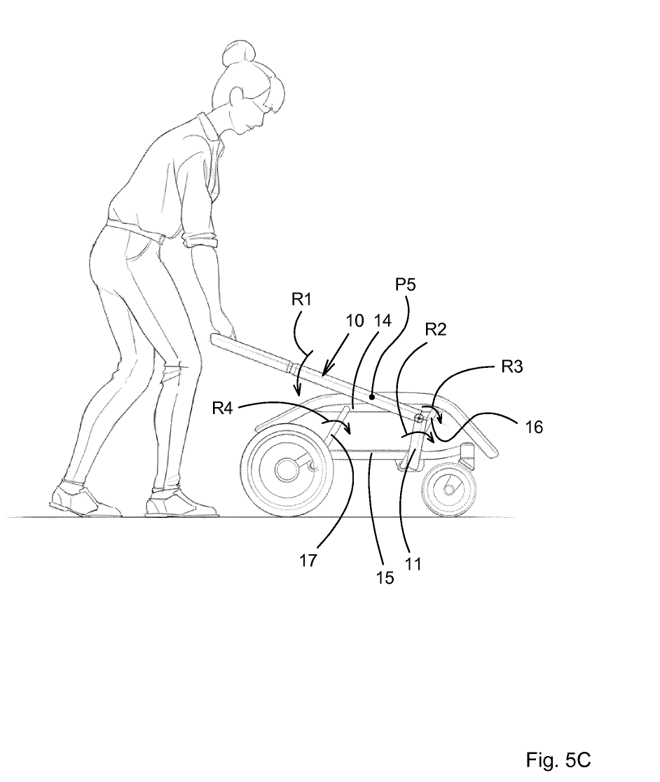

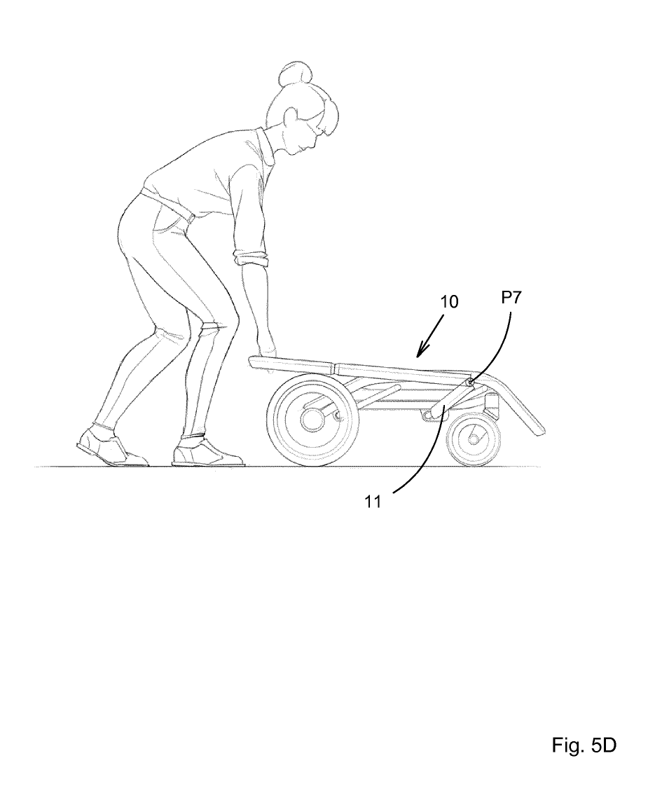

As can best be seen in FIG. 4A showing a schematic view of the folding mechanism of the stroller in the erect position, the fifth pivot P5 is located between the third pivot P3 and the forth pivot P4, whilst the first pivot P1 is located between the second pivot P2 and the sixth pivot P6. As can be seen in the FIGS. 2 and 5A, in the erect position of the stroller 1, the first part 10 and the second part 11 of the push bar 6 are in line with each other.

The stroller 1 is further provided with a locking mechanism to detachably lock on both sides of the stroller the first part 10 and the second part 11 of the push bar 6 with respect to each other in the erect position of the stroller 1 to prevent collapsing of the four-bar linkage mechanisms 7.

The lock can for example be a pin which is slidable under spring force from the first part 10 partly into the second part 11 in the erect position of the stroller 1. The bridge part 8 is provided with a push button 18 to unlock the locking mechanism. In case of the given example pushing on the push button 18 will cause the pin to be retracted against spring force out of the second part 11 and fully into the first part 10. Other locking mechanisms are also possible, for example whereby a slidable movement of the upper portion 13, unlocks a pivot, for example pivot P6 or P7, in the four-bar linkage mechanisms 7.

As can be seen in the figures the front bars 16 and the rear bars 17 are inclined towards the forward direction, whilst the first part 10 and the second part 11 of the push bar 6 are inclined towards the rearward direction.

FIG. 4B shows a schematic view of the folding mechanism 4 of the stroller 1 in a partially collapsed position of the stroller 1. When collapsing the folding mechanism 4 after unlocking the locking mechanism, the first part 10 of the push bar 6 is pivoted about pivot P5 with respect to the upper bar 14 in a counter clockwise direction R1. By doing so, the second part 11 of the push bar 6 will be pivoted about pivot P6 with respect to the lower bar 15 in a clockwise direction R2. Also the front bar 16 and the rear bar 17 will be pivoted about pivot P1, P2 with respect to the lower bar 15 in a clockwise direction R3, R4, respectively. During the pivoting of the front bar 16 and the rear bar 17, the upper bar 14 will be moved towards the lower bar 15, whilst maintaining in a parallel relationship therewith. As can be seen, during folding of the stroller 1, the first part 10 of the push bar 6 pivots in opposite direction with respect to the upper bar 14 as the front bar 16 and the rear bar 17, whilst the second part 11 pivots in the same direction with respect to the lower bar 15 as the front bar 16 and the rear bar 17.

FIGS. 5A-5D show side views of the stroller 1 during folding of the stroller 1 from the erect position as shown in FIG. 5A to the fully collapsed position as shown in fire 5D.

Starting from the fully erect position as shown in FIG. 5A, a user will push on the push button 18 on the bridge part 8, after which she can slide the upper portion 13 into the lower portion 12 in the direction as indicated by arrow T1. See FIG. 5B.

When pushing the push button 18 also the locking mechanism between the first part 10 and the second part 11 of the push bar 6 can be unlocked. It is also possible that the locking mechanism is being unlocked by the sliding movement of the upper portion 13 into the lower portion 12.

After or during inserting the upper portion 13 into the lower portion 12 or simultaneously therewith, the user will push the handle formed by the bridge part 8 downwards, whereby the first part 10 of the push bar 6 is pivoted about pivot P5 with respect to the upper bar 14 in a counter clockwise direction R1. By doing so, the second part 11 of the push bar 6, the front bar 16 and the rear bar 17 will be pivoted about pivot P6, P1, P2 with respect to the lower bar 15 in a clockwise direction R2, R3, R4, whereby the upper bar 14 will be moved towards the lower bar 15. FIG. 5C shows a partially collapsed position of the stroller 1. By further pivoting the first part 10 of the push bar 6 about pivot P5 with respect to the upper bar 14 in the counter clockwise direction R1, the stroller 1 is folded in the collapsed position as shown in FIG. 5D.

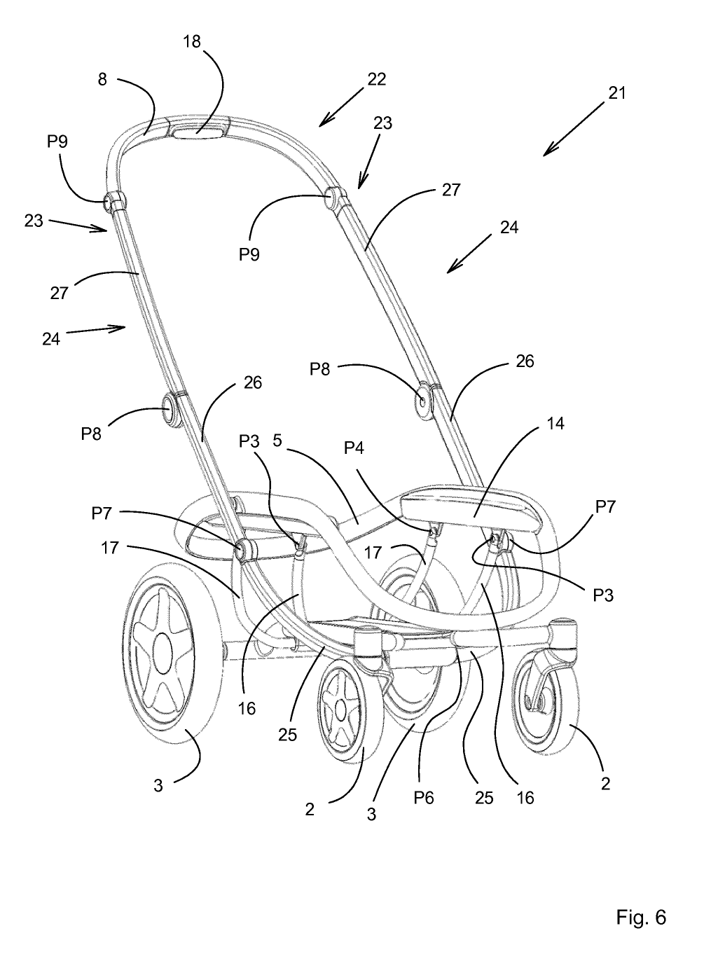

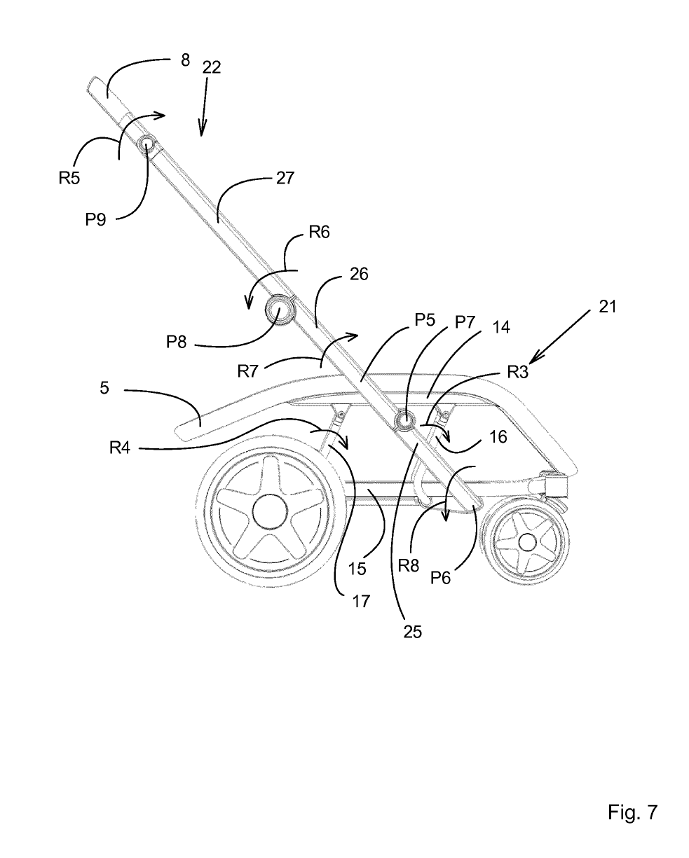

FIGS. 6 and 7 show a perspective view and side view of a second embodiment of a stroller 21 according to the invention.

The stroller 21 differs from the stroller 1 only by having a push bar 22 instead of push bar 6.

The push bar 22 is U-shaped and comprises a bridge part 8 and two leg portions 23. The bridge part 8 forms the handle of the push bar 22. Each leg portion 23 comprises a foldable first part 24 and a second part 25. The first part 24 is provided with a lower portion 26 and an upper portion 27 which is pivotably connected at pivot P8 to the lower portion 26. The upper portion 27 is pivotably connected at pivot P9 at a side remote of the lower portion 26 to the bridge part 8.

The first part 24 and the second part 25 are pivotably connected at pivot P7.

To fold the stroller 21 from the erect position as shown in FIGS. 6 and 7, a user will push on the push button 18 on the bridge part 8, after which she can pivot the bridge part 8 in clockwise direction R5 with respect to the upper part 27, pivot the upper part 27 in counter clockwise direction R6 with respect to the lower part 26 and pivot the lower part 26 of the first part 24 in clockwise direction R7 with respect to the upper bar 14. By doing so, the second part 25 of the push bar 22 will be pivoted in counter clockwise direction R8 with respect to the lower part 14 and the front bar 16 and the rear bar 17 will be pivoted about pivot P1, P2 with respect to the lower bar 15 in a clockwise direction R3, R4.

During these movements, the upper bar 14 will be moved towards the lower bar 15 until the stroller 21 is fully collapsed.

As can be seen, during folding of the stroller 21, the first part 24 of the push bar 22 pivots in the same direction with respect to the upper bar 14 as the front bar 16 and the rear bar 17, whilst the second part 25 pivots in the opposite direction with respect to the lower bar 15 as the front bar 16 and the rear bar 17.

The pivoting of the first part of the push bar 6, 22 about the pivot P5 in respectively the counter clockwise direction R1 and the clockwise direction R7 is facilitated in that by the stroller 1 the pivot P7 lies below a line through the pivots P5 and P6, whilst by the stroller 21 the pivot P7 lies above a line through the pivots P5 and P6.

By all embodiments the ends of the first part 10, 24 and the second part 11, 25 are pivotably connected at a pivot P7 being a different pivot than the pivots P5, P6, where the first part 10, 24 is pivotably connected to the first bar of the four-bar linkage mechanism 7 respectively where the second part 11, 25 is pivotably connected to the second bar of the four-bar linkage mechanism 7. In the erect position, the pivot P7 between the first part 10, 24 and the second part 11, 25 is located between and at a distance of the pivot P5 of the first part 10, 24 and the first bar of the four-bar linkage mechanism 7 and the pivot P6 of the second part 11, 25 and the second bar of the four-bar linkage mechanism 7.

It is also possible to use other kinds of four-bar linkage mechanisms than a parallelogram linkage mechanism. However, the parallelogram linkage mechanism has the advantage that a very compact collapsed stroller can be obtained.

It is also possible to position the pivot P5 behind or in front of the pivots P3 and P4. It is also possible to position the pivot P6 behind or between the pivots P1 and P2.

It is also possible to lock the first part and the second part of the push bar indirectly with respect to each other, for example by locking the first bar with respect to the upper bar, or by locking the second bar with respect to the lower bar. In this way, the first bar and the second bar are also prevented from pivoting with respect to each other.

By the two above described embodiments, the connect the first part and the second part of the push bar are pivotably connected to bars of the four-bar linkage mechanism, being connected to each other by other bars. It is also possible to connect the first part and the second part of the push bar to bars of the four-bar linkage mechanism, which are directly pivotably connected to each other.

The person skilled in the art will realize that the present invention is by no means limited to the preferred embodiments. Other variations to the disclosed embodiments can be understood and effected by those skilled in the art in practicing the claimed invention, from a study of the drawings, the disclosure, and the appended claims.

In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the scope should not be construed as limiting the scope of the claims.

### LIST OF REFERENCE SIGNS

1 stroller
2 wheel
3 rear wheel
4 folding mechanism
5 frame
6 push bar
7 four-bar linkage mechanism
8 bridge part
9 leg portion
10 first part
11 second part
12 lower portion
13 upper portion
14 upper bar
15 lower bar
16 front bar
17 rear bar
18 push button
21 stroller
22 push bar
23 leg portion
24 first part
25 second part
26 lower portion
27 upper portion
P1 first pivot
P2 second pivot
P3 third pivot
P4 fourth pivot
P5 fifth pivot
P6 sixth pivot
P7 seventh pivot
P8 pivot
P9 pivot
R1 counter clockwise direction
R2 clockwise direction
R3 clockwise direction
R4 clockwise direction
R5 clockwise direction
R6 counter clockwise direction
R7 clockwise direction
R8 counter clockwise direction
T1 arrow

1. A stroller being foldable from an erect position to a collapsed position and vice versa, which stroller comprises
a collapsible folding mechanism provided with a push bar and at least one four-bar linkage mechanism, wherein the push bar comprises a first part provided with a handle, which first part is pivotably connected to a first bar of the four-bar linkage mechanism, which push bar further comprises a second part pivotably connected to a second bar of the four-bar linkage mechanism, whilst ends of the first part and the second part are pivotably connected at a pivot to each other, which pivot being a different pivot than the pivots, where the first part is pivotably connected to the first bar of the four-bar linkage mechanism respectively where the second part is pivotably connected to the second bar of the four-bar linkage mechanism, wherein the first part and the second part are detachably lockable with respect to each other in the erect position of the stroller to prevent collapsing of the four-bar linkage mechanism.

2. The stroller according to claim 1, wherein the first part and the second part of the push bar are detachably lockable with respect to each other at least near the pivot.

3. The stroller according to claim 2, wherein in the erect position of the stroller, the first part and the second part of the push bar are in line with each other.

4. The stroller according to claim 1, wherein the four-bar linkage mechanism is a parallelogram linkage mechanism.

5. The stroller according to claim 4, wherein the four-bar linkage mechanism comprising comprises an upper bar a lower bar, a front bar and a rear bar, wherein the lower bar is pivotably connected at a first pivot and a second pivot to the front bar and the rear bar respectively, whilst the upper bar is pivotably connected at a third pivot and a fourth pivot to the front bar and the rear bar respectively, wherein the first part of the push bar is pivotably connected at a fifth pivot to the upper bar and the second part of the push bar is pivotably connected at a sixth pivot to the lower bar, whilst ends of the first part and the second part are pivotably connected to each other at the pivot, being the seventh pivot.

6. The stroller according to claim 5, wherein at least in the erect position at least one of the first part and second part of the push bar extend in another direction as the front bar and the rear bar.

7. The stroller according to claim 6, wherein the fifth pivot is located between the third pivot and the forth pivot whilst the first pivot is located between the second pivot and the sixth pivot.

8. The stroller according to claim 7, wherein during folding of the stroller, the first part of the push bar pivots in opposite direction with respect to the upper bar as the front bar and the rear bar, whilst the second part pivots in the same direction with respect to the lower bar as the front bar and the rear bar or vice versa.
